(19) United States
(12) Patent Application Publication
(10) Pub. No.: US 2006/0239683 A1
(43) Pub. Date: Oct. 26, 2006

(54) Wavelength-division-multiplexed passive optical network

(75) Inventors: Keun-joo Park, Yongin-Si (KR); Hyun-chin Kim, Seongnam-si (KR); Young-kwang Seo, Seoul (KR); Yeong-bae Yeo, Daegu (KR); June-koo Rhee, Seongnam-si (KR); Chun-ju Youn, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/359,508

(22) Filed: Feb. 23, 2006

(30) Foreign Application Priority Data
Apr. 21, 2005 (KR) 2005-0033038

(51) Int. Cl. H04J 14/00

(52) U.S. Cl. 398/71

(57) ABSTRACT

Disclosed is a wavelength-division-multiplexed (WDM) passive optical network which comprises an optical network unit (ONU) for receiving and transmitting an optical communication service; a remote node having an amplifier for amplifying wavelength of light as being transmitted from the optical network unit; and a central office for receiving the amplified light. In accordance with the WDM passive optical network described herein, it is possible to enhance the quality of the optical communication service provided by the optical network.

### CROSS-REFERENCE TO RELATED APPLICATIONS

This application claims priority from Korean Patent Application No. 2005-33038, filed on Apr. 21, 2005, the entire content of which is incorporated herein by reference.

### BACKGROUND OF THE INVENTION

1. Field of the Invention

The present invention relates to a wavelength-division-multiplexed passive optical network, and more particularly, to a wavelength-division-multiplexed passive optical network which is capable of providing good quality signals.

2. Description of the Related Art

A wavelength-division-multiplexed passive optical network (hereinafter, referred to as “WDM PON”) provides a very high-speed broadband communication service by using an intrinsic wavelength as given to each subscriber. As a result, it is possible to ensure that a secret of communication is kept, to easily receive any additional communication service or increased capacity as each subscriber requests, and to easily increase the number of subscribers by adding an intrinsic wavelength to be given to a new subscriber.

In spite of the aforementioned merits, the WDM PON has not yet been practicable because it requires a light source having specific oscillation wavelength between a central office (CO) and each subscriber terminal and requires an additional wavelength stabilization circuit for stabilizing the light source, and because it accordingly burdens the subscriber with a high price. In this regard, it is required to develop an economic wavelength-division-multiplexed light source to realize the WDM PON.

For the wavelength-division-multiplexed light source, there are suggested the distributed feedback laser array (DFB laser array), the multi-frequency laser (MFL), the spectrum-sliced light source, and the mode locked Fabry-Perot laser with incoherent light. Although a distributed feedback laser diode (DFB-LD) is a light source which only oscillates in the wavelength of one band, it is an expensive light source.

The spectrum-sliced light source has received active study. This source is capable of providing a great number of wavelength-divided channels by spectrally slicing the optical signals of a broad bandwidth by means of an optical filter or a waveguide grating router (WGR). Thus, the spectrum-sliced light source does not require any specific oscillation wavelength light source or any equipment for the wavelength stabilization.

For the spectrum-sliced light source, the following are potential light sources: the light emitting diode (LED); super-luminescent diode (SLD); Fabry-Perot laser diode (FP-LD); fiber amplifier light source; and ultra-short optical pulse light source. In the mode-locked FP-LD with incoherent light, if the optical signals of the broad bandwidth generated from the incoherence light source such as the LED or fiber amplifier light source are spectrally sliced by the optical filter or waveguide grating router (WGR) and then are injected in the FP-LD wherein an isolator is not mounted, the FP-LD generates only a wavelength which is identical with the wavelength of the spectrally sliced and injected signals and outputs that identical wavelength.

The distributed feedback laser array and the multi-frequency laser are expensive elements because these are manufactured by a complicated process and these require the accurate wavelength selectivity of the light source and the wavelength stabilization for the wavelength-division-multiplex system. In this regard, a cost-effective LED is suggested as the spectrum-sliced light source.

However, an LED light source has a very broad bandwidth and thus, it is distributed according to wavelength bands by an optical router such as the WGR. That is, even though signals of the broad bandwidth are input, the wavelength of the intrinsic band only is passed. Thus, it is possible to apply the LED as the wavelength-division-multiplexed light source. However, since the output intensity of the LED is low, long distance transmission of data is difficult.

In addition, since the output power of the LED is low, there is another problem in that it is impossible to increase a transmission speed of data.

### SUMMARY OF THE INVENTION

Accordingly, it is an aspect of the present invention to provide a wavelength-division-multiplexed optical network, which is capable of transmitting good quality optical signals when a light emitting diode is selected as an upstream light source.

According to an aspect of the present invention, there is provided a wavelength-division-multiplexed passive optical network which comprises an optical network unit (ONU) for receiving and transmitting an optical communication service; and a remote node having an amplifier for amplifying wavelength of the light as being transmitted from the optical network unit; and a central office for receiving the amplified light.

In accordance with another aspect of the present invention, the central office has a pump means for amplifying the amplifier.

In accordance with another aspect of the present invention, the optical network unit uses an LED as a light source from which the light is transmitted.

In accordance with another aspect of the present invention, the amplifier comprises an isolator for amplifying only the light as being transmitted from the optical network unit to the direction of the central office and passing the amplified light.

In accordance with another aspect of the present invention, the amplifier is an erbium-doped fiber (EDF).

In accordance with another aspect of the present invention, the wavelength of the light as being amplified by the pump means has a band of 1.3 μm or 1.51 μm.

In accordance with another aspect of the present invention, the pump means is a pump laser diode (pump-LD).

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a constitutional block diagram of a wavelength-division-multiplexed passive optical network according to an exemplary embodiment of the present invention;

FIG. 2 shows a remote node of FIG. 1 in detail; and

FIG. 3 is a table comparing a conventional optical network and the optical network according to an exemplary embodiment of the present invention, with respect to their respective performance, such as electric power.

### DETAILED DESCRIPTION OF THE EXEMPLARY EMBODIMENTS

One exemplary embodiment of the present invention will be described in detail with reference to the included drawings. Where the function and constitution are well-known in the relevant arts, further discussion will not be presented in the detailed description for the purpose of clarity.

The present invention has an object to solve the aforementioned problems occurring when an LED is selected as a light source for upstream transmission in a wavelength-division-multiplexed passive optical network.

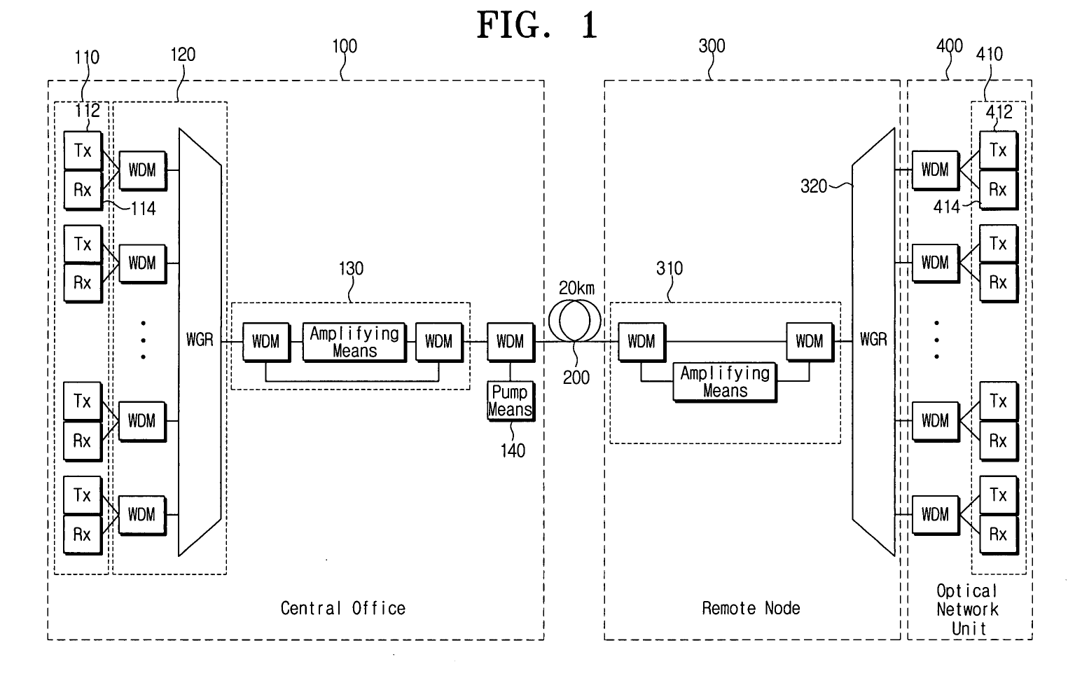

FIG.1 is a constitutional block diagram of a wavelength-division-multiplexed passive optical network according to an exemplary embodiment of the present invention.

The wavelength-division-multiplexed passive optical network according to the exemplary embodiment of the present invention comprises a central office (CO) 100, an optical fiber 200, a remote node 300, and an optical network unit (ONU) 400.

The central office 100 transmits a number of optical wavelength signals to the optical network unit 400, and first and second wavelength-division-multiplexed (WDM) waveguide grating routers (WGRs) 120 and 320 mechanically distribute the wavelengths determined to each optical network unit 400. Thus, the central office 100 is provided with a number of transmitters (TX) 112 and a number of receivers (RX) 114. One wavelength band as distributed is transmitted to one subscriber.

A first amplifier 130 of the central office 100 is an element to be included when an LED 412 is selected as a downstream source. However, the first amplifier 130 is an optional element which may not be applied when the LED 412 is selected as the upstream source as in the present invention. Thus, the optical network without a first amplifier 130 is in accordance with an exemplary embodiment of the present invention.

Further, the first amplifier 130 may be applied by the same principles as in a second amplifier 310 which will be described later.

The upstream wavelengths from the optical network unit 400 to the direction of the central office 100 are different from the downstream wavelengths from the central office 100 to the direction of the optical network unit 400, and the upstream wavelengths are determined according to the optical network unit 400, respectively. Each of the different upstream wavelengths is multiplexed in the first and second WDM WGRs 120 and 320, and the multiplexed wavelength is transmitted to the central office 100.

For the upstream communication, the optical network unit 400 uses the LED 412 of a broad bandwidth as a light source. An exemplary embodiment of the present invention is capable of transmitting the light having the wavelengths of the broad bandwidth from the LED 412 to the direction of the central office 100 according to their respective wavelengths.

In the wavelength-division-multiplex system, corresponding wavelength is accessed to each subscriber by oscillating each wavelength in one band. However, since the LED 412 used in an exemplary embodiment of the present invention is the light source having a number of wavelengths oscillating at the same time, a technique for selecting only one band is required.

The technique of dividing the wavelengths according to bands is called the spectrum slicing technique, and this technique means a WDM-PON system.

For example, in the case of using the FP-LD as the light source, if the light having a predetermined wavelength is input in the WDM WGR, only the wavelength of one band is output from the WDM WGR such that the oscillation of the light source corresponds to the wavelength of the light as being input and entering. That is, although the wavelengths corresponding to a number of wavelengths originally oscillate, it is possible to divide the wavelengths according to bands, by using the effect of selecting only one wavelength in a specific case, i.e., when an intrinsic wavelength is input.

However, in a conventional WDM-PON system, since output from the LED 412 is too low, the LED is not selected as the light source for the upstream transmission. However, according to the present invention, it is possible to amplify the output of the LED 412 by using the pump means 140 in the central office 100.

For upstream transmission, the wavelengths of the LED 412 selected as the light source oscillating in the wavelengths with a number of bands are divided according to bands by the first and second WDM WGRs 120 and 320. While, the wavelengths with a number of bands are united by the first and second WDM WGRs 120 and 320 and output. That is, even though the light source having wavelengths with a number of bands are input, only the optical signals corresponding to the intrinsic wavelength are output.

Even though the wavelengths of a broadband are oscillated by the LED 412, only the band corresponding to the intrinsic wavelength is output by the characteristics of the first and second WDM WGRs 120 and 320, as described above.

Even though the LED 412 is selected as the light source as in an exemplary embodiment of the present invention, it is possible to perform the wavelength-division-multiplex system by using the characteristics of the first and second WDM WGRs 120 and 320. However, since the output power of the LED 412 is too low as described above, it is necessary to solve that problem. The light source such as the DEP-LD has high output power since it only oscillates in one band. However, the LED 412 has lower output power since it oscillates in broad bands and further only one band amongst them is selected.

Such low output power makes it impossible to perform the long distance transmission. That is, only if greater power than the receiving power of the RX 114 in the central office 100 is input, it is possible to receive predetermined signals, without errors. Nevertheless, the LED 412 selected as the light source in an exemplary embodiment of the present invention originally has very low output power, and loss power by the optical fiber occurs in a receiving process. Here, another problem is additionally caused by the low output power, in that it is impossible to increase the transmission speed.

The pump means 140 is used to solve the aforementioned problems caused by the low output power of the LED 412. It is possible to apply the LED 412 as the light source for the high-speed transmission, which is greater than 300 Mb/s to 600 Mb/s, by using the pump means 140 in the central office 100. A pump laser diode (pump-LD) used as the pump means 140 amplifies the output power of the LED 412 by means of the second amplifier 310 which will be described later.

The first and second WDM WGRs 120 and 320 which are utilized in the central office 100 and the remote node 300, respectively, multiplex the channel signals, which are input in turn by a number of input terminals, in one output terminal and output the multiplexed signals, simultaneously multiplexing the WDM signals, which are input though one input terminal, in a number of output terminals and outputting the multiplexed signals.

That is, through the first WDM WGR 120 of the remote node 300, a number of wavelength-divided downstream channel signals which are input in turn through a number of input terminals are multiplexed in one output terminal and output, at the same time when a number of wavelength-division-multiplexed upstream channel signals which are input through the input terminal are de-multiplexed in output terminals and output.

In the same manner, through the second WDM WGR 320 of the remote node 300, a number of wavelength-division-multiplexed downstream channel signals which are input through one input terminal are de-multiplexed in a number of output terminals and output, at the same time when a number of upstream signals which are input in turn through the input terminals are multiplexed in one output terminal and output. This function of the present invention is possible by using the characteristics of the elements of the WGR. That is, utilization of the characteristics of the WGR in that the output terminal is determined by the wavelength of the optical signals as being input in the input terminal.

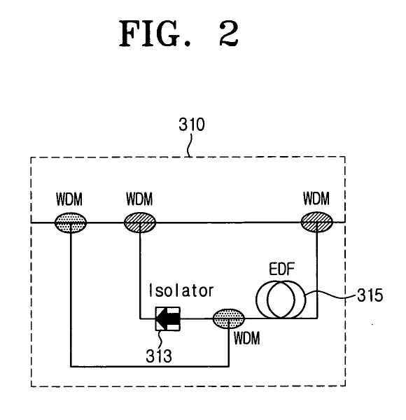

With reference to FIG. 2 showing the second amplifier 310 in detail, in the case of the upstream transmission of data, the optical signals pass through the erbium-doped fiber (EDF) 315 in the remote node 300. As shown in FIG. 1, in the case of the downstream transmission, the optical signals do not pass through the EDF 315 upon the data is downstream transmitted. However, an isolator 313 is provided at the side of the central office 100 from the optical network unit 400 in order that the optical signals pass through the EDF 315 in the case of the upstream transmission.

Here, the EDF 315 as the amplifier is a kind of passive elements, wherein, by doping erbium, the amplification is possible within the wavelength band of 1.5 μm or 1.3 μm as being usable in the optical communication. Erbium is known as the single substance which can be amplified in the band of 1.5 μm.

As the pump means 140 is used in the central office 100, it is possible to amplify the wavelength in the second amplifier 310. As the pump means 140 oscillates in the band of 0.98 μm, the amplification of 0.98 μm is performed by the pump means 140, and consequently, energy is supplied to the amplifier of the remote note 300, thereby making it possible to apply the LED 412 used in the broadband of 1.5 μm as the light source of the optical network.

After all, the present invention is significant in that the LED 412 is selected as the upstream source by the remote pumping technique of additionally using the pump means 140 in the central office 100.

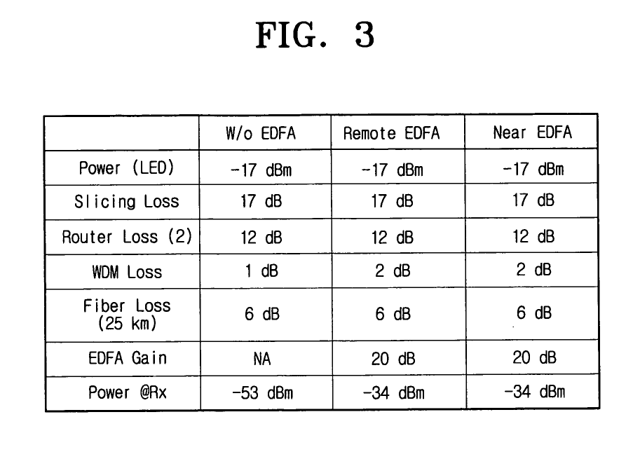

Specifically, the background that the pump means 140 is used in the central office 100 will be described in reference to FIG. 3 comparing the performance, such as power, of the conventional optical network and the optical network according to the present invention.

In the table of FIG. 3, there are represented, in the longitudinal direction, a conventional optical network without an EDF amplifier (W/o EDFA), an optical network using a remote EDF amplifier (Remote EDFA) according to the present invention, and an optical network using a near EDF amplifier (Near EDFA). A first row in the transverse direction indicates output power of the LED selected as the light source of the optical network, the rows below the first row indicate losses of various kinds as the numerical values, respectively, and the last row indicates optical power as being input in the receiver by calculating the sum of the losses.

The output power is the same in all three optical networks. However, the receiving optical power is only −53 dBm in the W/o EDFA but −34 dBm in both Remote EDFA and Near EDFA. This means that, it is difficult to generally use a conventional optical network (W/o EDFA) as the optical network because the receiving optical power should be greater than −34 dBm in order that the output transmission speed of the light source is 600 Mb/s.

Referring to the Near EDFA and the Remote EDFA according to an exemplary embodiment of the present invention, the two seem to have no difference with respect to the numerical values representing the output power or the sum of losses as shown in FIG. 3. However, the optical signal to noise ration (OSNR) are not the same in the Near EDFA and the Remote EDFA optical networks.

That is, although the same power is input, all signals are noisy. Here, a penalty is to measure the noise. For example, in order to obtain the bit error rate (BER) of 10⁻⁹ by the same output power, much greater power than the −30 dBm is required.

The Near EDFA or Remote EDFA can output the received optical power of −34 dBM, however, the OSNR is inferior in the Near EDFA.

Formula 1 indicates the OSNR of each of the Near EDFA and Remote EDFA.
OSNR(Remote)=58−22(Pout)−6(NF)−20(Gain)=10 dB OSNR(Near)=58−22(Pout)−6(NF)−20(Gain)=4 dB [Formula 1]

Based on Formula 1, the transmission is impossible with the value of 4 dB as the OSNR of the Remote EDFA. While, transmission at the speed of 600 Mb/s with the value of 10 dB as the OSNR of the Near EDFA is possible.

Thus, the Remote EDFA according to the present invention is satisfied with the OSNR as well as the received optical power in the central office of the optical network, as described above, thereby making it possible to use the LED 412 as the light source of the optical network and to provide good quality communication by minimizing the losses of the optical signal.

According to an exemplary embodiment of the present invention, there is an advantage of realizing high quality optical communication service by using the light emitting diode as the light source for the optical communication by comprising the pump means in the central office and the amplifier in the remote node.

The foregoing embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A wavelength-division-multiplexed passive optical network comprising:
an optical network unit for which receives and transmits an optical communication service;
a remote node which has an amplifier which amplifies wavelength of light transmitted from the optical network unit; and
a central office which receives the amplified light from the remote node.

2. The optical network as claimed in claim 1, wherein the central office comprises a pump means which amplifies the amplifier.

3. The optical network as claimed in claim 1, wherein the optical network unit comprises a light emitting diode operating as a light source from which the light is transmitted.

4. The optical network as claimed in claim 1, wherein the amplifier comprises an isolator which amplifies only the light from the optical network unit to the direction of the central office and passes the amplified light.

5. The optical network as claimed in claim 1, wherein the amplifier comprises an erbium doped fiber.

6. The optical network as claimed in claim 2, wherein the wavelength of the light as amplified by the pump means has a band of 1.3 μm or 1.5 μm.

7. The optical network as claimed in claim 2, wherein the pump means comprises a pump laser diode.

8. The optical network as claimed in claim 1, further comprising at least on optical network unit.

9. The optical network as claimed in claim 8, wherein the at least one optical unit uses an LED which has a broad bandwidth as a light source for upstream communication.

10. The optical network as claimed in claim 8, wherein the central office transmits light of a plurality of wavelengths the at least one optical network unit.

11. The optical network as claimed in claim 10, further comprising a first wavelength-division-multiplexed waveguide router and a second wavelength-division-multiplexed waveguide router.
